(19) United States
(12) Patent Application Publication
(10) Pub. No.: US 2003/0228083 A1
(43) Pub. Date: Dec. 11, 2003

(54) Fiber optical probes for temperature measurement with high speed

(76) Inventor: Yaosheng Chen, Blacksburg, VA (US)

Correspondence Address: Yaosheng Chen, 200 Country Club Drive Bldg D, Blacksburg, VA, 24060, US

(21) Appl. No.: 10/164,584

(22) Filed: Jun. 10, 2002

(51) Int. Cl. G02B 6/00

(52) U.S. Cl. 385/12

(57) ABSTRACT

The present invention involves new, innovative optical fiber probes, applied for temperature measurement with a quick response time. This new type of probe is composed of an IR wave-guide, including the following: a wave-limiter; a wave-splitter, an exponent/logarithm transfer, a logarithmic subtractive device, a self-adjustable wave-cutting device, and an opto-electric probe head. The probe quickly responds to temperature, 1 ms or less, then releases the data captured digitally. This invention, offering numerous possible widespread applications, could replace thermocouples and sensors utilized for contact and non-contact measurement, as well as become an ideal for standard temperature measurement. The dual-waves optical method and the digital technique of the optics are both applied to this invention. Based on the above-mentioned, multi-functional fiber optical sensors, capable of measuring a variety of biological, chemical, and physical quantities, can be developed.

### FIELD OF INVENTION

The present invention relates to the optics of fiber sensors and nano technology. The probe will have widespread applications in temperature measurement, contact or non-contact; also to be applied as a standard tool for temperature measuring. The invented technology along with dual-wave optics and digital optics will have commercial prospects in a field such as optical fiber sensors; including optical and opto-electric instruments.

### BACKGROUND OF THE INVENTION

It is understood that the principle of thermocouples is based on a closed return circuit, formed by two types of metals. When two link points of the metals are at different temperatures, the current produced is in the return circuit. The electromotive force thus occurs between two link points. The above phenomenon is known as the Seebeck effect.

Temperature exists in the inertia. When a subject is heated, temperature increases; balance and diffusion remain slow processes. As the temperature decreases, cool down, balance still remains a slow process as well as heat absorption. Regardless of whether the temperature is increasing or decreasing, the value constantly fluctuates before a balance, a medium, is reached. Unfortunately, the thermocouple utilized presently is not able to monitor the complete process mentioned above.

In general, the thermocouple is widely used due to its low cost and ease of installation. However, obvious disadvantages exist; a slow response time is encountered, about 1 minute, a high margin of error occurs during measurement, as high as 20%, and an additional compensating wire is required at the cool end. Additionally, the thermocouple cannot withstand certain circumstances, such as confronting a high electric field or dealing with radiation emitted from a magnetic field. In the modern industry, computers require sensors to have a quick response time. If a new thermocouple model could increase the response time without increasing the cost, great social and economic benefits would be rewarded. The present invention, which applies a fiber optical probe instead of the currently utilized thermocouple, is ready to revolutionize this change for temperature measurement.

In the inventor's previously awarded patent (U.S. Pat. No. 6,375,910 BI), a fiber optical instrument for non-contact measuring temperature was based on the Plack radiation law; composed of an optical lens, optical fibers, the wave-cutting device of multi-wavelengths, and opto-electric probes. The instrument maintains a high level of accuracy and a quick response time, but is only capable of measuring the temperature of a subject's surface.

In the above-mentioned non-contact temperature-measuring instrument, an optical lens was placed at the front end. The distance from the measured object to the lens was at least ten times greater than that of the focal length of the lens. The optical fiber was found to be able to reach the surface of the measuring object more closely once the lens was removed. A possibility to submerge inside the object exists if the optical fiber to be used can resist heat. The experiments conducted found that although the signals produced were decreased, displaying the temperature after the lens was removed was not a problem; confirming that the invented method not only applies to non-contact measurement, but also to submerging measurement possibilities, offered by current thermocouples.

### SUMMARY OF THE INVENTION

The present invention includes an infrared wave-guide design, which includes a wave-limiter, a wave-splitter, an exponent/logarithm transfer, and a logarithmic subtractive device. The wave-guide can transmit middle- and far-infrared lights for a long distance, reaching digital output after a connection to the self-adjustable wave-cutting device occurs. A cost efficient probe can obtain the opto-electric transfer, by transmitting pulses. Evidence is available to prove that the invented fiber optical probe is capable of the following: a wide measuring range, a quick response time, and a high level of accuracy all in regard to temperature measurement.

### BRIEF DESCRIPTION OF THE DRAWINGS

The present invention may be best understood by way of the following description of a method employing the principles of the invention as illustrated in the accompanying drawings, in which:

FIG. 1 shows the total structure diagram of the invention.

REFERENCE NUMERALS IN DRAWING

| | |
|---|---|
| 1. Wave-limiter | 2. Wave-splitter |
| 3. Exponent/logarithm transfer | 4. Logarithmic subtractive |
| 5. Self-adjustable wave-cutting device | device |
| 7. Absorb washer | 6. Infrared probe |
| 9. Protect cover | 8. Outer shell |
| 11. Display of liquid crystal | 10. Push button |
| 13. Battery | 12. Circuit plate |
| | 14. Plug |

FIG. 2 is the principle diagram of the logarithmic subtractive device; in which 15 is a light filtering film, and 16 is a reflective film of the wave-guide.

FIG. 3 is the structural diagram of the self-adjustable wave-cutting device, in which 17 is a self-adjustable vibration film, 18 is an absorption ball for stray light, and 19 is a grating.

FIG. 4 is the fiber optical sensor's probe 20, shown in detail. To monitor multi physical and chemical quantities and optical digital transmitting, only the nano-materials on the probe must be modified.

### DETAILED DESCRIPTION

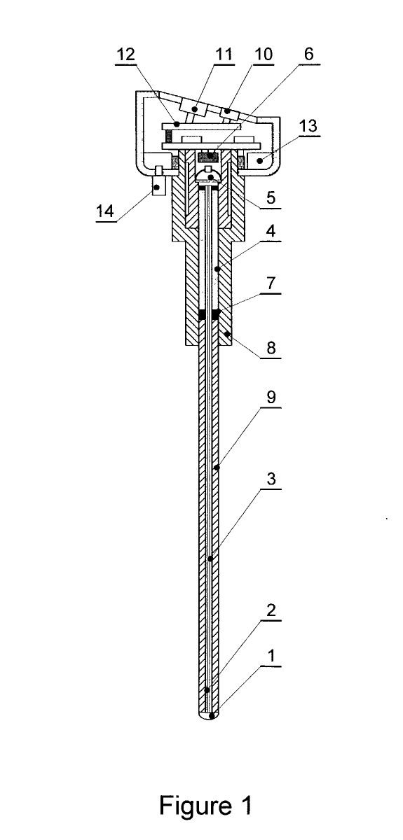

The present invention is one type of probe of the optical fiber, which is to be applied for rapid temperature measurement. Refer to FIG. 1 for a full structure diagram. When the probe is inserted into the object to be measured, the infrared wave from object's radiation is received. The object's composition, whether loose or solid, or structure, whether big or small, is irrelevant; all can be measured. Aimed at a certain distance from the object, the probe is also capable of receiving the infrared signals emitted.

In fact, the optical fiber's probe is an infrared wave-guide. The wavelength's window of a general optical fiber composed of quartz is between 0.4 μm and 2.0 μm. The probe by use of this fiber, mentioned above, can measure the temperature of an object of 752° F. (400° C.) or above. Even if the temperature exceeds 1832° F. (1000° C.), the said fiber can still function in regard to non-contact measurement. However, in a submerge measuring case, the materials utilized to compose the optical fiber must be able to withstand high temperatures, above 1000° C., such as the blue gem fiber. When the measuring temperature is below 752° F., especially below room temperature, a quick response time and a high level of accuracy is difficult to maintain.

The present invention applies a quartz capillary instead of the wave-guide at the low temperature block. The capillary has a diameter of 1˜2 mm, and an inside hole diameter of 50˜300 μm. The middle IR (3˜7 μm) is able to pass through the capillary inside the wave-guide, length of 1000 mm; an 80% transmission level can be achieved The outside surface of the capillary is covered by a nano refractive film, such as Au, Ag, and Li. This type of nano film can easily be adjusted to control the thickness, between 40 and 200 μm, while maintaining a relatively low cost.

A heated object, any size, is a wave source. At this temperature, of the heated object, the optimum wavelength of radiation correlates, the same temperature. The optimum wavelength will shift to the direction of the short wave as temperature increases. In specific cases, involving certain waves, radiation power increases as the temperature increases, known as the Plank law.

$$W = {ϵ}_{λ ( T )} {\frac{{C}_{1}}{{λ}^{5}} [ exp ( \frac{{c}_{2}}{λ T} ) - 1 ]}^{- 1} \qquad ( 1 )$$

Where W is the power of light at the known wavelength with the corresponding temperature, C₁ and C₂ are constant, and ε_{λ(T)} is the radiation coefficient, a function of λ and T. ε_{λ(T)} can also be modified by utilizing different materials. For example, ε=1 if the radiation is emitted by the blackbody. In order to remove the radiation coefficient, the powers obtained from two adjacent wavelengths must be compared, i.e. powers W₁□W₂ are obtained from wavelengths λ₁□λ₂. Suppose

$${R}_{( T )} £ \frac{1}{2} \frac{{W}_{1}}{{W}_{2}} .$$

can be expressed as:

$${R}_{( T )} = \frac{{W}_{1}}{{W}_{2}} = {[ \frac{{λ}_{2}}{{λ}_{1}} ]}^{5} exp [ \frac{{C}_{2}}{T} ( \frac{1}{{λ}_{2}} - \frac{1}{{λ}_{1}} ) ] \qquad ( 2 )$$

First, in practice, radiation from a heat source, entering the wave-limiter 1, functions to allow only two waves with wavelength λ₁, λ₂ to enter the waveguide. The wave-limiter is, in fact, a block film of the visible light; only a wave-block with a wavelength above 0.76 μm is able to pass through. In general, the film is composed of polymers, such as polyethylene and polypropylene. The end surface can be molded, resembling a lens shape, to increase the diameter of the infrared wave-guide's hole.

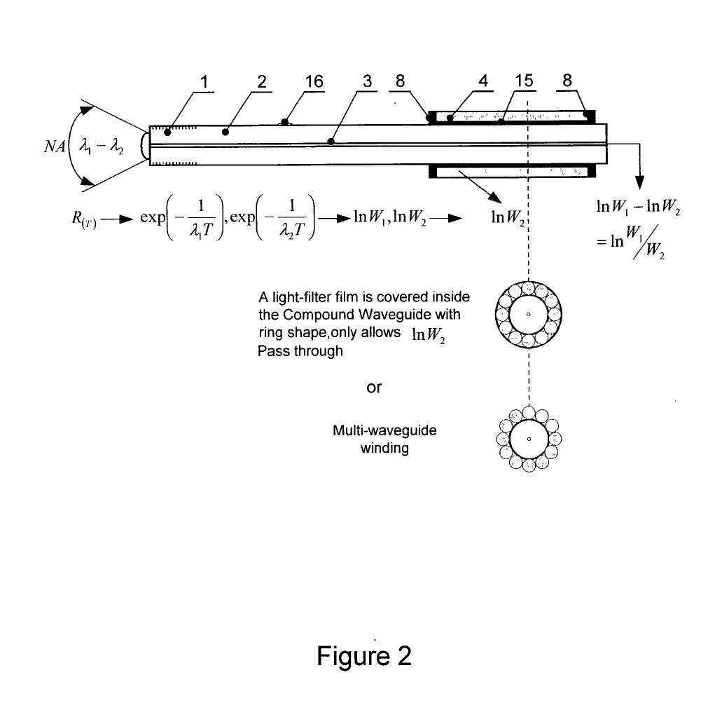

Second, the light wave will enter into the wave-splitter 2, formed by a photoeching method of grating on the outer circle of the wave-guide; the splitter 2 resembles the Bragg Grating of the optical fiber. The refractive wave will then divide a wide spectrum into two separate narrow-band spectra, or one narrow-band and one wide-band spectrum by adjusting the grating constant. The grating is then covered with a nano carbon film, 20 mm in length. The layer of carbon film applied forms a blackbody to adsorb stray lights emitted before the exponent/logarithm transfer occurs. The energy from the incident light transmits into the wave-guide in the form of an exponent, an anti-function of the logarithm. Values are between 0 and 1. In the following case, if a compound film composed of nano silicon crystal and polymer was previously painted on the inside wall of the capillary, the width of λ₁□λ₂ would shift rapidly towards the long-wavelength direction. A compress function effect would occur, as well as a 3˜7 μm spectra enhancement, if the film's layers utilized were between 20 and 50. The compressed waves then enter into the logarithmic subtractive device 4; this principle idea is shown in FIG. 2. Based on equation (2), the following is now assumed:

ln R_{(T)=}ln W₁−ln W₂ (3)

Once the two waves enter into the logarithmic subtractive device 4, λ₂ will fall into a coupling waveguide due to a λ₂ transmission film 15 on the outer rim of the circle. The photon energy of λ₂, ln W₂, is absorbed by an adsorption layer 8 on both end surfaces of the wave-guide; λ₁ corresponding energy, ln W₁, will follow along through to the main wave-guide. The total energy in

$$ln {W}_{1} - ln {W}_{2} = ln \frac{{W}_{1}}{{W}_{2}}$$

can be compared to that of the dual-wavelength. The radiation coefficient is eliminated as well as environmental disruptions.

The photon energy,

$$ln \frac{{W}_{1}}{{W}_{2}} ,$$

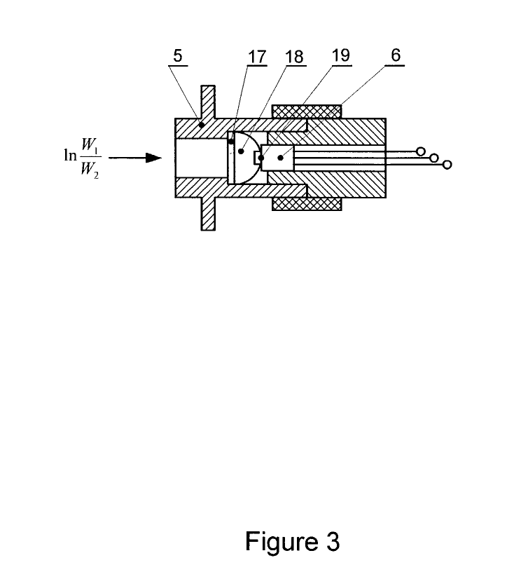

gathered from the logarithmic subtractive device 4, drives the self-adjustable wave-cutting device 5. As the photon energy passes through the vibration film 17, lights emitted produce a shift and scanning phenomenon; vibration frequency fluctuations occurring while photon energy strength changes, is the cause of the above-mentioned. Light, from the grating 19, converts into a light signal with a digital pulse, received by an infrared probe 6. Inside the probe, the optical digital value becomes an electric digital signal. FIG. 3 shows structure details, describing the basic principle of the wave-cutting device. The vibration film 17 utilized is a compound film, composed of magnetic particles and polymer, on the substrate of polyester.

When an infrared light illuminates the above compound film, a deformation of the polyester film occurs, the continuous change of ordered direction arrangement in the polarized magnetic molecules is the cause; the electric and magnetic field in the light beam alternate. This type of deformation results transmission light scanning. An integrate ball of stray light 18 is able to absorb any light emitted at the edge. Lights on the axis will pass disconnectedly through the grating 19; can be replaced by a micro-lens constructed of polymer.

The sequence of optical pulses, with varying frequencies, released from the grating, is the optical digital signals. The signals are able to transmit over long distances or can be received directly by an opto-electric probe. In the present invention a cost efficient thermo-electric probe is applied.

The digital signals carrying electric pulses, from above probe, display the corresponding temperature value onto a liquid crystal screen 11; a signal treating circuit 12 allows the above-mentioned. A variety of measured data is obtainable by utilizing the functional push button 10; another option is to connect to a computer to display the data.

The nano-film of TIC 16 on the Infrared wave-guide and the nano-film of carbon on the wave-splitter can be adjusted by using the metal protecting sleeve, i.e. outer shell 8 and protect cover 9. The optical fiber can be used directly without utilizing the mentioned protection.

When the optical fiber probe is submerged into a high temperature environment, such as liquid steel, the material of the infrared waveguide will be constructed of blue gem from the optical fiber. In this case, a ceramic material, heat expansion efficient, similar to the blue gem, can replace the metal protecting sleeve.

Concluding from the above that, the optical fiber probe will first absorb the infrared light wave, gained from the heat source. The λ₁˜λ₂ wide band spectrum then divides into a dual-wavelength spectrum by passing through the wave-limiter and wave-splitter simultaneously before entering into the exponent/logarithm transfer 3 and the logarithm subtractive device 4; the comparison of the dual-wavelength can be concluded at this point. Lastly, the self-adjustable wave-cutting device 5, obtains the optical digital signals, performing the temperature measurement with high speed and accuracy. Therefore, based on the principle of non-contact temperature measurement, the present invention does achieve contact measuring of the temperature. The digital transfer is realized by the utilization of the following: the wave-splitter 2, the logarithm subtractive device 4, and the self-adjustable wave-cutting device 5, all of the present invention. The A/D exchange, carried out in the head of the sensor, increases the anti-disruption abilities of the sensor, as well as provides a method to resolve the issue of transmitting signals of the sensor over along range.

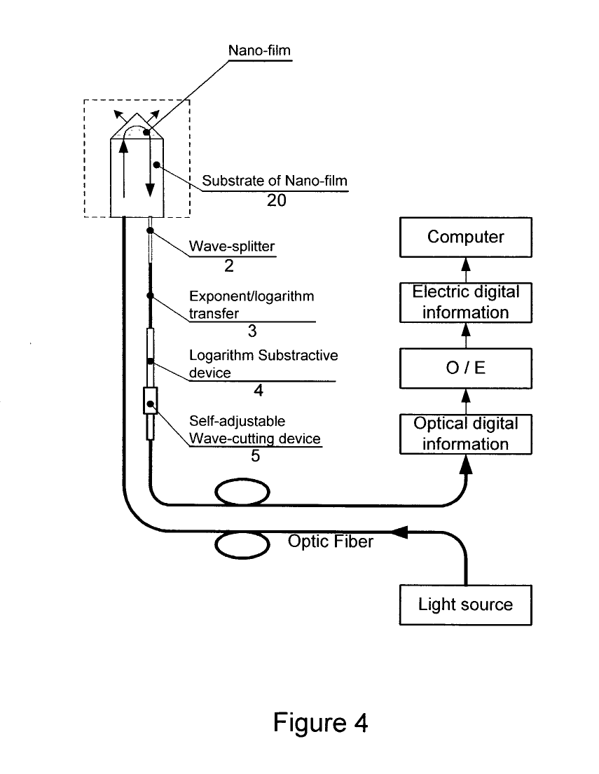

FIG. 4 shows an expanded application for this invention. Lights from the LED transmit to the sensor head, modulated by the measured biological, chemical, and physical quantities. A portion of the light flows into the measuring field, while other portions of the light reach the A/D exchange by the following: the wave-splitter 2, the logarithm subtractive device 4, and the self-adjustable wave-cutting device 5. The signals, transmittable long-range, throughout the optical fiber, perform the data analysis.

The head of the sensor 20 can be constructed out of a variety of materials, quartz, blue gem, and dual-refractive crystals, varying in shape such as a lens or prism. The end fragment can be painted with a variety of corresponding nano films to achieve quick and accurate measurements for various situations, such as temperature, pressure, velocity, density, concentration, refractive index, toxic gases, and bacteria.

We claim:

1. The present invention relates to a fiber optical probe for the high-speed measurement of temperature. A main feature of the probe is the infrared wave-guide, composed of the wave-limiter, the wave-splitter, exponent/logarithm transfer, and the logarithm subtractive device. The infrared light wave emitted from the heat source is selectively divided into two sequent waves by the waveguide. The dual-waves are compared and divided by the exponent/logarithm transfer and the logarithm subtractive device; negative material and environmental effects are eliminated. Next, lights sourcing from the logarithm subtractive device convert into a single sequence, driving the self-adjustable wave-cutting device to perform the A/D exchange and optical digital transmission. The opto-electrical probe then obtains the sequence of signals with electric pulses, i.e. 1,0,1,0, . . . digital signals, which indicate the measuring temperature. On the sensitive end of the invented optical fiber sensor, optical strength converts to optical digital signals.

2. The Infrared wave-guide and the self-adjustable wave-cutting device, described in claim 1, are able to connect to other light-transmitting optical fiber as well creating a variety of optical fiber digital sensors options. In this case, the wave-guide and the light-transmitting fibers' head end are welded into a ball shape; connecting to an optical sensitive element is an additional option. Once the head end is placed into the measuring field, the refractive light of the light-transmitting fiber will be subjected to modulation, based on the quantity measurement. Meanwhile, the reflective light returns back into the infrared waveguide. The reflective light will represent the quantity size of the measurement. The reflective light achieves optical digital transmission by the following: the wave-splitter, the logarithm subtractive device, and the self-adjustable wave-cutting device. A quick response time (≦1 ms) and a high level of accuracy towards the measurement are achieved. The nano film utilized on the head end of the sensor will determine the sensitivity level.

3. The wave-splitter, in claim 2, is a grating of the optical fiber. The reflective wave utilized, emitted by the grating itself, divides the spectrum into two wave blocks. In the present invention, the dual-wavelength comparison is achieved by the use of its own transmission spectrum. The multi-wavelength comparison occurs after a long-period grating has divided the spectrum further, into more wave blocks. Light, transmitted from the wave-splitter, enters into the logarithm subtractive device via the exponent/logarithm transfer. Values are between 0 and 1.

4. The logarithm subtractive device, in claim 3, is based on the principle of the type X coupler. The wave-guide's multi-rings are swept towards the exiting end of the infrared waveguide, 20 to 100 mm in length. A glass tube can replace the above-mentioned, to cover the exiting end of the infrared wave-guide.

5. Between the main infrared wave-guide and the winded wave-guide, described in claim 4, there is a ln W₁ transmission film coating; continuously allows one wavelength light only to pass through to the main wave-guide, while multi-wavelength light enters into the logarithm subtractive device, other wavelengths are all adsorbed into the winded wave-guide. The light wave, remaining in the main wave-guide, now enters into the self-adjustable wave-cutting device.

6. The self-adjustable wave-cutting device, in claim 5, involves a compound film composed of magnetic particles and polymer materials; produces a deformation when illuminated by an infrared light. The period of the deformation and the frequency are in proportion to the light strength. This deformation of the compound film, results in a defection of the transmission light. The infrared probe thus achieves illumination with discontinuity, and the light digital quality converts into electric digital quality.

7. The self-adjustable wave-cutting device, in claim 6, offers yet another feature, if a metal ball, half-cylinder in shape, painted black inside, along with a mix of compound and polyester film, possessing strong IR transmission, is in place, stray light will be absorbed; the infrared probe will directly be illuminated by light emitted from the grating. A polymer lens is a suitable substitute for the grating; the corresponding pulse would pass through, reaching optical digital transmission.
